(19) United States
(12) Patent Application Publication
(10) Pub. No.: US 2026/0035574 A1
(43) Pub. Date: Feb. 5, 2026

(54) CHROME-FREE COATINGS WITH SCHIFF BASES HAVING IMPROVED SOLUBILITY AND METHODS THEREOF

(71) Applicant: The Boeing Company, Arlington, VA (US)

(72) Inventors: Dipanwita CHATTERJEE, Bangalore (IN); Benjamin Ayres LINK, Orlando, FL (US); Waynie Mark SCHUETTE, Troy, IL (US); Ava Paloma SWITZER, St. Louis, MO (US)

(73) Assignee: The Boeing Company, Arlington, VA (US)

(21) Appl. No.: 19/058,627

(22) Filed: Feb. 20, 2025

Related U.S. Application Data
(60) Provisional application No. 63/677,278, filed on Jul. 30, 2024.

(51) Int. Cl. C09D 5/08; C09D 133/24; C09D 163/00; C09D 183/04

(52) U.S. Cl. CPC C09D 5/086; C09D 133/24; C09D 163/00; C09D 183/04

(57) ABSTRACT

A method of forming a corrosion inhibiting composition is disclosed, including performing a simulation of candidate thiosemicarbazone derivative molecules to determine a solubility parameter associated with a structure of the plurality of candidate thiosemicarbazone derivative molecules, selecting one or more bulky substituent groups to react with a thiosemicarbazone based on one or more results of the simulation, adding the one or more bulky substituent group, which may include an amine-functional group, to a reaction vessel. The method also includes generating a dithiocarbamate quaternary ammonium salt including one of the bulky substituent groups and precipitating a thiosemicarbazone derivative having one of the bulky substituent groups. The one or more bulky substituent groups may include a cyclohexyl group, a 2-ethyl group, a 3-ethyl group, such as 2-ethylphenyl and 3-ethylphenyl, or a combination thereof. Additional methods incorporating polar substituent groups and corrosion inhibiting compositions and treatments are also disclosed.

### CROSS-REFERENCE TO RELATED APPLICATIONS

This application claims the benefit of U.S. Provisional Patent Application No. 63/677,278, filed on Jul. 30, 2024, which is hereby incorporated by reference in its entirety.

### STATEMENT OF GOVERNMENT INTEREST

This invention was made with Government support under contract number W912HQ-21-C-0067 awarded by the Department of Defense. The government has certain rights in this invention.

### TECHNICAL FIELD

The present teachings relate generally to chrome-free coatings and, more particularly, to chrome-free coatings having Schiff bases with improved solubility.

### BACKGROUND

The use of chromium-containing corrosion inhibitors has been widespread for decades because of its performance and durability with respect to the prevention of corrosion on steel, aluminum, and other alloys used in aerospace manufacturing. Recently, the use of chromium-containing corrosion inhibitors is being restricted by regulations on a global basis.

Schiff bases (SB) have exhibited strong corrosion inhibition properties when coated on aluminum alloy panels and can be added to a chromium-free post treatment solution for other plated steel substrate materials. However, the reduced solubility of the Schiff bases limits the concentration of the inhibitor when incorporated into a polymeric film. This limited solubility then impacts corrosion properties of the metal passivation layer. Schiff base inhibitors that have been synthesized include planar symmetry due to π-π interactions between layers of aromatic rings. If this planarity from the aromatic rings in the Schiff base inhibitor could be disrupted, the solvent-solute interaction can become stronger than solute-solute interaction. If successful, Schiff base inhibitor molecules with larger bulky groups or steric hindrance can provide comparatively higher solubility.

Thus, there is a need for providing corrosion inhibition compositions including Schiff base inhibitors having improved solubility, and developing methods for designing and fabricating such corrosion inhibition compositions.

### SUMMARY

The following presents a simplified summary in order to provide a basic understanding of some aspects of one or more embodiments of the present teachings. This summary is not an extensive overview, nor is it intended to identify key or critical elements of the present teachings, nor to delineate the scope of the disclosure. Rather, its primary purpose is merely to present one or more concepts in simplified form as a prelude to the detailed description presented later.

A method of forming a corrosion inhibiting composition is disclosed. The method of forming a corrosion inhibiting composition includes performing a simulation of a plurality of candidate thiosemicarbazone derivative molecules to determine a solubility parameter associated with a structure of the plurality of candidate thiosemicarbazone derivative molecules. The method also includes selecting one or more bulky substituent groups to react with a thiosemicarbazone based on one or more results of the simulation. The method also includes adding one or more bulky substituent group each including an amine-functional group to a reaction vessel containing carbon disulfide and triethylamine. The method also includes generating a dithiocarbamate quaternary ammonium salt that includes one or more bulky substituent groups. The method also includes precipitating a thiosemicarbazone derivative including one or more bulky substituent groups. Other embodiments of this aspect include corresponding computer systems, apparatus, and computer programs recorded on one or more computer storage devices, each configured to perform the actions of the methods. Implementations of the method of forming a corrosion inhibiting composition includes where the one or more bulky substituent groups may include a cyclohexyl group. The one or more bulky substituent groups may include a 2-ethyl group, a 3-ethyl group, or a combination thereof. The one or more bulky substituent groups is selected from a group including 2-ethylphenyl and 3-ethylphenyl. The one or more bulky substituent groups are selected from a group including aryl groups. The method of forming a corrosion inhibiting composition may include dissolving the thiosemicarbazone derivative into a solvent to confirm a solubility of the corrosion inhibiting composition or polymerizing the thiosemicarbazone derivative into a polymeric resin. The polymeric resin may include an epoxy, a polyimide, a polyamide-imide, a polyimide, or a polysiloxane.

Another method of forming a corrosion inhibiting composition is disclosed which includes performing a simulation of a plurality of candidate Schiff base derivative molecules to determine solubility parameters associated with a structure of the plurality of candidate Schiff base derivative molecules. The method also includes selecting one or more bulky substituent groups to react with a Schiff base based on one or more results of the simulation. The method also includes adding a molecule that includes the one or more bulky substituent groups to a reaction vessel containing the Schiff base. The method also includes generating a Schiff base derivative including the one or more bulky substituent groups and precipitating the Schiff base derivative. Other embodiments of this aspect include corresponding computer systems, apparatus, and computer programs recorded on one or more computer storage devices, each configured to perform the actions of the methods. Implementations of the method of forming a corrosion inhibiting composition include where the one or more molecules including the one or more bulky substituent groups may include 4-chloro-3-nitrobenzaldehyde. The method of forming a corrosion inhibiting composition may include dissolving the Schiff base derivative into a solvent to confirm a solubility of the corrosion inhibiting composition, and polymerizing the Schiff base derivative into a polymeric resin.

A corrosion inhibition coating composition is disclosed including a polymer resin, and a thiosemicarbazone derivative, and where the thiosemicarbazone derivative may include one or more bulky substituent moieties. Implementations of the corrosion inhibition coating composition include where the one or more bulky substituent moieties may include a cyclohexyl group. The one or more bulky substituent moieties may include a 2-ethyl group, a 3-ethyl group, a polar 4-chloro-3-nitrophenyl group, or a combination thereof. The one or more bulky substituent moieties is selected from a group including 2-ethylphenyl, 3-ethylphenyl, and 4-chloro-3-nitrophenyl. The bulky substituent moieties are selected from a group including aryl groups. The corrosion inhibition coating composition has a thickness ranging from about 1 micrometer to about 10 micrometers. The thiosemicarbazone derivative may include a thiosemicarbazone of isophthalaldehyde or a thiosemicarbazone of terephthalaldehyde. The polymeric resin may include an epoxy, a polyimide, a polyamide-imide, a polyimide, or a polysiloxane.

The features, functions, and advantages that have been discussed can be achieved independently in various implementations or can be combined in yet other implementations further details of which can be seen with reference to the following description.

### BRIEF DESCRIPTION OF THE DRAWINGS

The accompanying drawings, which are incorporated in and constitute a part of this specification, illustrate embodiments of the present teachings and together with the description, serve to explain the principles of the disclosure. In the figures:

FIG. 1A depicts an application of a structural component including an adhesive composition applied to an aerospace vehicle. FIG. 1B is an exploded view of a portion of the aerospace vehicle of FIG. 1A, in accordance with the present disclosure.

FIG. 2 is a reaction scheme illustrating a chemical reaction used in methods for forming a corrosion inhibiting composition, in accordance with the present disclosure.

FIG. 3 is a plot depicting relative solvation energy as a function of dielectric constant of solvent, in accordance with the present disclosure.

FIG. 4 is a plot depicting absolute sum of dihedral angles of thio-groups relative to a central benzyl ring as a function of dielectric environment, in accordance with the present disclosure.

FIG. 5 is a plot depicting solubility parameters of bulky substituents computed via molecular dynamic simulations, in accordance with the present disclosure.

FIG. 6 is a reaction scheme illustrating is a flowchart illustrating a method of forming a corrosion inhibiting composition, in accordance with the present disclosure.

FIG. 7 is a flowchart illustrating a method of forming a corrosion inhibiting composition, in accordance with the present disclosure.

FIG. 8 is a flowchart illustrating a method of forming a corrosion inhibiting composition, in accordance with the present disclosure.

It should be noted that some details of the figures have been simplified and are drawn to facilitate understanding of the present teachings rather than to maintain strict structural accuracy, detail, and scale.

### DETAILED DESCRIPTION

Reference will now be made in detail to exemplary embodiments of the present teachings, examples of which are illustrated in the accompanying drawings. Wherever possible, the same reference numbers will be used throughout the drawings to refer to the same, similar, or like parts.

Schiff bases (SB) or bis-functional SBs of the present disclosure exhibit strong corrosion inhibition properties when coated on aluminum alloy panels and can be added to a chromium-free post treatment solutions for ZnNi, Zn and Cd plated steel. The current formulations, however, have reduced solubility of the SB that limits the concentration of the inhibitor in the polymeric film. This lower concentration impacts corrosion properties of the metal passivation layer. The SB inhibitors synthesized to-date have planar symmetry due to π-π interactions between the layers of aromatic rings. Hypothetically, to disrupt the planarity from the aromatic rings, the design of a class of bis-functional SBs having bulky substituents such that the solvent-solute interaction becomes stronger than solute-solute interaction can influence the reduced solubility. Molecular dynamics (MD) simulation results show a trend in the solvation energies, and it is observed that the molecule with larger bulky groups and steric hindrance result in higher solubility.

It is expected that the planar structure of the known Schiff base corrosion inhibitors limits its solubility ultimately affecting the corrosion inhibition properties. The present disclosure proposes designing of the molecules such that the intermolecular interaction is weaker compared to solvent-solute interaction. This can provide improved, higher concentration of the SB in the coating solutions and promote development of chromium free solution as a post-plating treatment for Zn, Zn—Ni, Cd plating and Al alloys that has improved performance over other Schiff base based corrosion inhibition coatings.

Existing zinc-nickel (ZnNi) passivation treatments are trivalent chromium, hexavalent chromium, and cobalt based. Most industries are trending towards developing completely chromium free metal passivation compositions or techniques. Additionally, chromate and cobalt containing metal passivation are subject to regulatory oversight and can have higher waste disposal costs associated with the heavy metal-based corrosion inhibition coating compositions.

The present disclosure further provides a method to improve the corrosion inhibiting properties of Schiff bases (SB) by improving the solubility of the SB in a polymeric film, including disrupting the planarity from the aromatic rings with bulky substituents chosen from one of the following four groups: a 2-ethylphenyl group, a 3-ethylphenyl group, a cyclohexyl group, and a polar 4-chloro-3-nitrophenyl group. The reduced intermolecular π-π stacking can improve, or raise, the concentration of the SB in the coating solution and promotes development of a chromium-free solution as a post-plating treatment for Zn, Zn—Ni, Cd plating and Al alloys that can provide enhanced corrosion inhibition performance as compared to other corrosion inhibition coatings including Schiff bases.

Used as a baseline, control molecule with respect to which solubility of the newly designed molecules are tested is a thiosemicarbazone of isophthalaldehyde, later shown as Formula a. This molecule has an aromatic ring which induces π-π stacking between the molecules in 3-dimension. Additional molecules have been designed with the introduction of bulky substituents as described later in Formula b, Formula c, and Formula d. The presence of bulky substituents like 2-ethyl and 3-ethyl group and cyclohexyl group is expected to introduce steric hindrance and reduce the π-π interaction by increasing the distance between the molecules in the stack. This is expected to increase the solubility of the molecules in common solvents used for the coating processes that provide metal substrates and surfaces with improved corrosion inhibition. Cyclohexyl groups exist in a chair or boat configuration and can be used as a steric hindrance inducing group in organic molecules. The molecule containing cyclohexyl group as a bulky substituent is expected to be the one having the highest solubility.

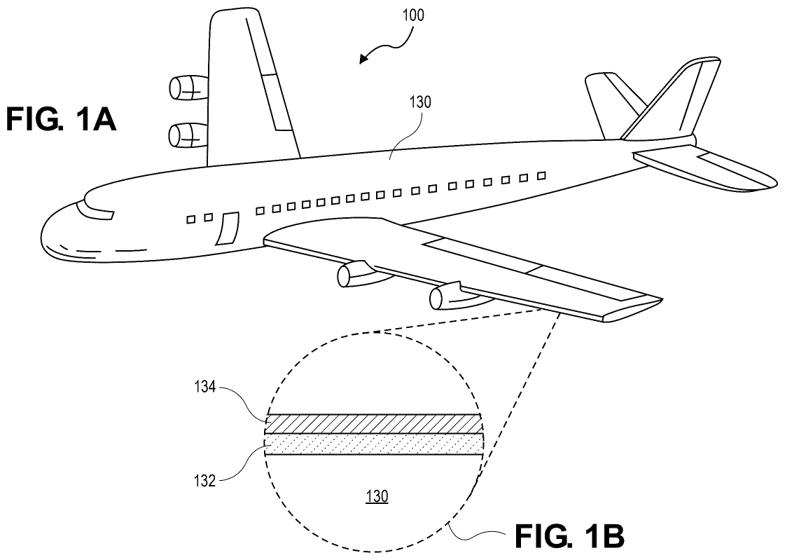

FIG. 1A depicts an application of a structural component including a corrosion inhibiting coating composition applied to an aerospace vehicle. FIG. 1B is an exploded view of a portion of the aerospace vehicle of FIG. 1A, in accordance with the present disclosure. An application of the presently disclosed coating composition or method is shown on an aerospace vehicle 100, whereby vehicle substrate 130 is applied with the presently disclosed corrosion inhibition coating composition. Exploded view FIG. 1B is shown, having vehicle substrate 130 or surface thereof with a substrate surface layer 132 and corrosion inhibition coating composition layer so as to adhere a corrosion inhibition layer 134 to a surface of the substrate 130, and/or onto a structural component of or onto a portion of a vehicle. In one example the application of the presently disclosed coating composition is directed to an external surface of the aerospace vehicle 100. In examples, additional coating layers, such as paints, coatings, or other protective coatings can be applied upon the corrosion inhibition coating composition layer. It should be noted that substrate surface layer 132 can be optional in certain examples.

In examples, substrates of the present disclosure can include composite materials. In examples, the substrate comprises a metal or metal alloy, for example, aluminum, stainless steel, titanium, low carbon steel, aerospace grade metals, or alloys thereof, or electroplated substrates such as ZnNi, Cd, and Zn plated substrates. Suitable substrates can alternatively comprise organic polymers such as PEKK, or Bismaleimides (BMI) resins, or inorganic materials including ceramics, such as, for example, silicon dioxide (SiO₂) or aluminum oxide (Al₂O₃). The substrate can include metallic or organic compositions, wherein the substrate is flat and/or has a low radius of curvature and/or has a high radius of curvature, depending on the nature of the application or the aerospace component in which it is used.

In other examples, composite material layers can include glass fibers, carbon fibers, aramid fibers, alumina fibers, ceramic fibers, or a combination thereof. Examples of polymer materials that can be used (e.g., as a substrate) that undergoes surface coating with a metallic coating or circuit layer in accordance with the present disclosure include polymer materials that act as a matrix in combination with one or more types of fibers or other reinforcing or functional additives. In one example, materials useful for the practice of the present disclosure include fiber-reinforced plastics (FRP) comprising a polymer material in combination with an inorganic fiber such as fibers of carbon, carbon nanotubes, graphite, fiberglass, glass, metals, metal alloys, or metalized fibers and metal coated glass fibers, alumina fiber or boron fiber. In one example, the fiber reinforced plastic can comprise organic fiber such as a nylon fiber or aramid fiber. In one example, the fiber reinforced plastic can comprise organic fiber and/or inorganic fiber blended into a thermosetting polymer, such as an epoxy resin material. In one example, a portion of a multilayered composite laminate may be constructed of multiple layers of thermoset layers, fiber layers, or a mixture thereof.

In one example, a carbon fiber reinforced plastic (CFRP) or glass fiber reinforced plastic (GFRP) as the polymer article made therefrom is used as a material suitable for aircraft structures or the like. However, the present disclosure is not restricted to these types of materials or any particular arrangement, and articles formed from other polymers can also be used in the presently disclosed process of the present disclosure. In one example, the polymer substrate comprises a crystalline polymer. Crystalline polymers provide high temperature resistance as well as chemical resistance to FRPs. For example, epoxy-based polymers are crystalline and can be thermally stable up to temperatures as high as 260° C. and possibly higher depending on the specific formulation and additives used. In another example, the polymer substrate comprises a semi-crystalline polymer. Semi-crystalline polymers provide the benefits of crystalline polymers along with ductility and processing advantages to FRPs. In yet another example, the polymer substrate comprises an amorphous polymer. Amorphous polymers provide resiliency, ductility and processing advantages to FRPs.

In one example the polymer substrate is selected from epoxies, phenolics, polyesters, polyesters, ureas, melamines, polyamides, polyimides, poly-ether-ether-ketones (PEEK), poly-ether-ketone-ketone (PEKK), polyetherimide (PEI), polyphthalamide, polyphthalates, polysulfone, polyurethanes, chlorinated polymers, fluorinated polymers, polytetrafluoroethylene, polycarbonates, liquid crystal polymers, partially crystalline aromatic polyesters, and modified versions thereof containing one or more fillers or reinforcement materials selected from carbon, carbon nanotubes, graphite, carbon fibers, graphite fibers, fiberglass, glass fibers, metals, metal alloys, metalized fibers and metal coated glass fibers.

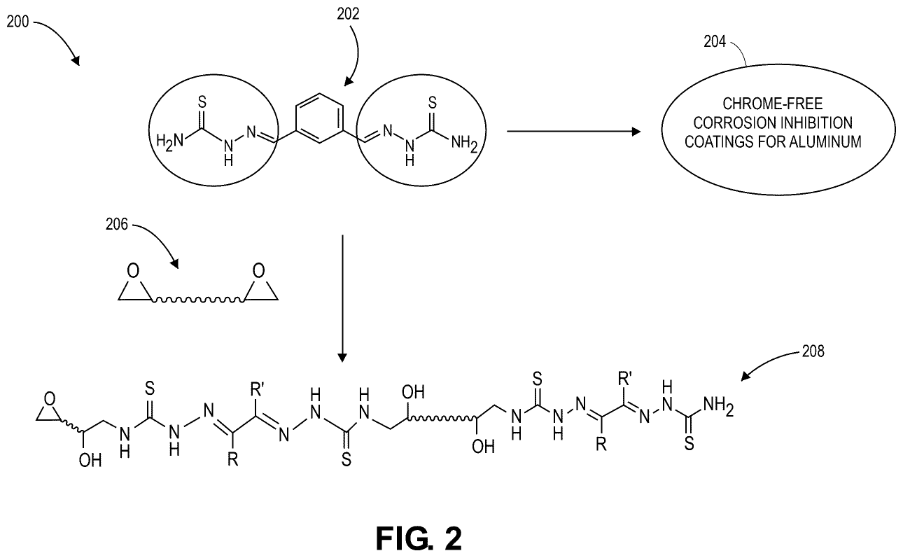

FIG. 2 is a reaction scheme illustrating a chemical reaction used in methods for forming a corrosion inhibiting composition, in accordance with the present disclosure. The general reaction scheme 200 provides an overview of creating polymeric Schiff bases as compared to previous examples of use of Schiff base materials in corrosion inhibition coating formulations. An example bis-thiosemicarbazone 202 is shown, which can be adopted for general use in chrome-free corrosion inhibition coatings for aluminum or other substrates 204, or as described in the present disclosure, the bis-thiosemicarbazone 202 can be reacted with a polymer precursor 206, in this instance, an epoxy-functional polymer precursor as shown to form a polymeric Schiff base 208. With the use of two molecules as controls, denoted as Formula a and Formula e, below, synthesis of polymeric Schiff base polymeric molecules from 2-ethyl amine (Formula b), 3-ethyl amine (Formula c), and cyclohexyl amine (Formula d), have been conducted, and will be described in greater detail herein. The synthesis substitutes thiosemicarbazide from the corresponding amines. The reaction of substituted thiosemicarbazone synthesis is through the reaction of isophthalaldehyde with the substituted thiosemicarbazide in acidic medium. The thiosemicarbazone derivatives (Formulae b-d) can be synthesized following the same scheme as described in FIG. 2.

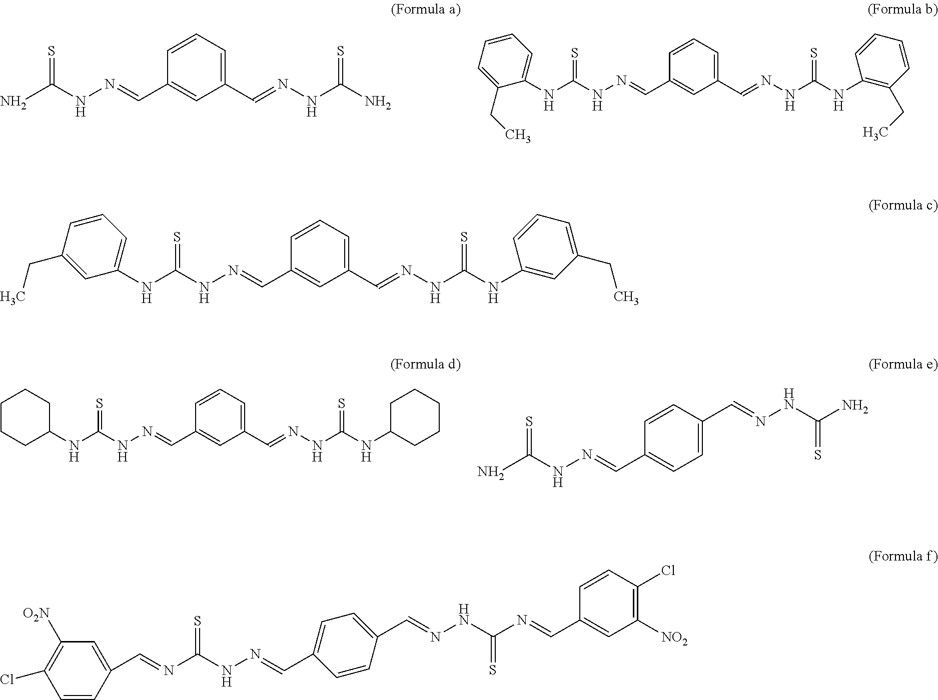 [SMILES: NC(=S)N/N=C/c1cccc(/C=N/NC(N)=S)c1 ; CCc1ccccc1NC(=S)N/N=C/c1cccc(/C=N/NC(=S)Nc2ccccc2CC)c1 ; CCc1cccc(NC(=S)N/N=C/c2cccc(/C=N/NC(=S)Nc3cccc(CC)c3)c2)c1 ; S=C(N/N=C/c1cccc(/C=N/NC(=S)NC2CCCCC2)c1)NC1CCCCC1 ; NC(=S)N/N=C/c1ccc(/C=N/NC(N)=S)cc1 ; O=[N+]([O-])c1cc(/C=N/C(=S)N/N=C/c2ccc(/C=N/NC(=S)/N=C/c3ccc(Cl)c([N+](=O)[O-])c3)cc2)ccc1Cl]

The present disclosure provides methods of synthesizing SBs having a thiosemicarbazone core unit linked to two aromatic rings through amine bonds, wherein one or both of these aromatic rings are substituted with bulkier groups such as 2-ethylphenyl, 3-ethlyphenyl, cyclohexyl, and polar functional group-containing moieties like 4-chloro-3-nitrobenzaldehyde. Other illustrative bulky substituent groups can include bromo cyclohexyl groups, phenyl sulfonic acid groups, tertiary butyl-phenyl groups, 2,4-diethyl phenyl groups, 2,4-di tertiary butyl phenyl groups. These bulky substituents disrupt the planarity of the overall molecular structure of the Schiff base, reducing π-π stacking interactions between adjacent molecules and increasing their solubility in common coating solutions such as acetone-dichloromethane mixtures acetone, NMP (N-Methyl-2-pyrrolidone)-ethanol, combinations thereof, or other solvent combinations.

In one example, a Schiff base can be synthesized by converting 2-ethylphenylamine or 2-ethylaniline to the corresponding thiosemicarbazide which then can be reacted to a bis functional aldehyde such as isophthalaldehyde in acidic medium to produce the desired SB having two aromatic rings linked through amine bonds, where the aromatic rings are substituted with a 2-ethyl group.

In another example, Schiff bases can be synthesized by converting cyclohexylamine or 3-ethlyaniline to the corresponding thiosemicarbazide derivative and then reacting with bis-functional isophthaldehyde in acidic medium to produce the desired SB having two bulky substituents. These SBs exhibit improved solubility due to the steric hindrance introduced by these bulkier groups, which is believed to be due to π-π stacking interactions between adjacent molecules.

In yet another example, Schiff bases can be synthesized using alternative methods involving 4-chloro-3-nitrobenzaldehyde as a starting material (such as in Formula VI). This approach allows for the introduction of additional benzene rings with polar functionalities like nitro and chloro functionalities into the molecular structure, further enhancing solubility within corrosion inhibition coating formulations while maintaining corrosion inhibition properties.

In still another example, Schiff bases can be synthesized using different solvent combinations such as toluene-xylene or hexane-acetone mixtures during condensation reactions. These alternative solvents may be used experimentally or theoretically evaluated through molecular dynamics simulation for their potential in improving coating processes and enhancing the overall performance of these polymerized SBs.

In yet another example, a combination of solvents such as acetone-dichloromethane mixtures can be used for optimal formulation conditions. This may involve adjusting the ratio of these solvents to achieve better dissolution properties while minimizing side reactions and byproducts formation during condensation reactions. The synthesized thiosemicarbazone derivatives of the present disclosure can be further modified through additional chemical transformations, such as alkylation or acylation reactions, to introduce new functional groups that enhance their corrosion inhibition properties. These modifications may involve the use of reagents like alkyl halides or acid anhydrides in combination with solvents and catalysts. Additional reactions may be necessary to further provide such modifications.

For further use in coating applications, these thiosemicarbazone derivative molecules may be polymerized or attached to a polymeric resin through various methods such as melt-processing, spin-coating, dip-coating, spray-coating, and solvent-casting. The resulting coatings are expected to exhibit enhanced adhesion properties on Al alloys and other surfaces or substrate materials that are susceptible to corrosion due to chemical bonding with metal oxides present at the surface of these materials.

Additional synthetic protocols or methods could include reaction of the thiosemicarbazone of isophthalaldehyde with 4-chloro-3-nitro benzaldehyde. This reaction can enable the addition of benzyl rings with polar nitro and chloro functionalities into the corrosion inhibition coating compositions. The bulky substituents along with the polar groups may result in increased solubility. The synthesis scheme for this reaction is described in greater detail herein.

The compounds indicated as Formula a-Formula e were further investigated by theoretical studies. Subsequent modeling strategies were employed to characterize the geometric changes as a result of bulky substituent addition. Multiscale modeling techniques utilizing quantum and classical mechanics characterizes relative energetics, solvation influence on planarity, and solute solvent mixing of each proposed thiosemicarbazone derivative.

To evaluate the effectiveness of these compounds as coatings for mild steel panels, the resulting polymers using the Schiff base compounds described herein may be applied onto mild steel panels or other substrate materials using conventional coating techniques such as spin-coating, dip-coating, spray-coating, and brush-coating. In examples, the polymerized resin can be a thermoplastic material that may be melt-processed and molded to form various shapes for use in corrosion protection applications. The resulting coatings are expected to exhibit excellent adhesion properties on mild steel surfaces due to their chemical bonding with metal oxides present at these interfaces. In examples, the use of solvents such as dichloromethane-tetrahydrofuran mixtures or other solvent combinations may facilitate efficient formation of desired products while minimizing side reactions and byproducts.

To optimize the coating process beyond the use of a polymeric resin attachment point, additional functional groups (e.g., hydroxyls) may be incorporated to enhance adhesion properties on mild steel surfaces or other substrate surfaces. Furthermore, alternative solvents such as acetone-dichloromethane mixtures or other solvent combinations for optimal coating processes that may offer improved dissolution properties without compromising corrosion inhibition performance. Furthermore, the polymerized resin can be a thermoset material formed through cross-linking reactions between functional groups present in the Schiff bases. This approach can enable the creation of coatings with tailored mechanical and thermal properties suitable for various industrial applications involving mild steel panels. Also, the use of additives such as surfactants or dispersants can improve coating uniformity and reduce defects.

To further enhance corrosion inhibition performance, additional coating layers may be applied on top of the initial polymerized resin layer through techniques like electroplating, chemical vapor deposition (CVD), or physical vapor deposition (PVD). These multi-layered coatings may provide enhanced protection against corrosive environments such as acidic or alkaline conditions. In examples, the combination of Schiff bases with different bulky substituents to create hybrid polymers that exhibit improved solubility and corrosion inhibition properties can be used. The polymerized resin can be designed for use in specific industrial applications involving mild steel panels or other substrate materials exposed to high-temperature environments (e.g., above 200° C.). In this case, the use of thermally stable monomers or cross-linking agents capable of withstanding elevated temperatures without compromising coating integrity can be integrated into corrosion inhibition compositions. The resulting coatings are expected to exhibit excellent thermal stability and resistance against degradation due to heat exposure.

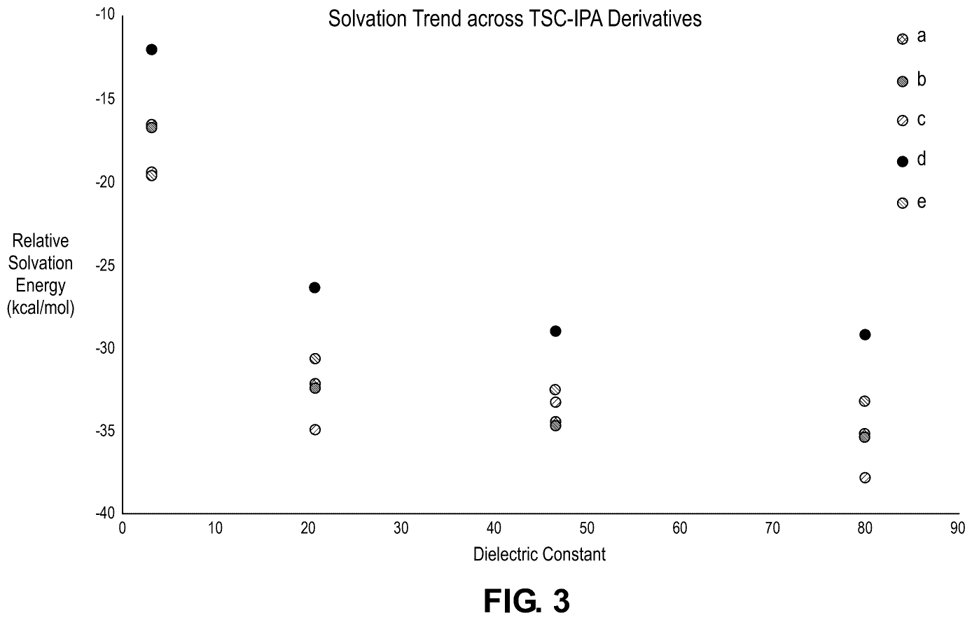

FIG. 3 is a plot depicting relative solvation energy as a function of dielectric constant of solvent, in accordance with the present disclosure. A solvation trend indicates a relative solvation energy as a function of dielectric constant of solvent. This trend indicates key distinctions in electronic structure environment upon addition of bulky substituents, as compared to the molecules represented by Formula a and Formula e. This supports the concept that the addition of terminal benzyl rings promote interactions in higher dielectric solvents such as water.

Theoretical studies were conducted to investigate these solvation properties of Schiff bases with bulky substituents using MD simulations and quantum mechanics (QM) simulations via density functional theory (DFT). DFT was employed to compute solvent-solute interactions between thiosemicarbazones in various dielectric media. Results showed that introduction of cyclohexyl group into the molecule usefully disrupted π-π stacking, leading to improved solubility due to increased distance between molecules and reduced intermolecular interactions. QM simulations were also used to corroborate this hypothesis by demonstrating useful changes in electronic structure environment upon addition of bulky substituents. The results indicated that introduction of candidate SB groups promoted flattening of structures, which may lead to π-π stacking collapse out of solution. MD calculations further supported these findings, revealing a “like dissolves like” relationship between solubility parameters and solvent dielectric constants. In another example, the MD simulations were used to investigate the effects of different bulky substituents on thiosemicarbazone solvation properties in various solvents. The results showed that introduction of 2-ethylphenyl group (Formula b), 3-ethlyphenyl group (Formula c) and cyclohexyl group (Formula d) usefully improved solubility compared to the control molecule, with the latter exhibiting highest solubility due to its steric hindrance-induced disruption of π-π stacking.

In another example, QM simulations were employed to investigate the effects of polar functional groups on thiosemicarbazone solvation properties. The results showed that introduction of 4-chloro-3-nitrobenzaldehyde (Formula f) as a bulky and polar substituent further enhanced solubility due to its additional reactive sites for metal ions or other species involved in corrosion reactions. In yet another example, DFT calculations were used to investigate the effects of solvent dielectric constants on thiosemicarbazone solvation properties. The results showed that increasing dielectric constant led to improved solubility and reduced π-π stacking interactions due to increased distance between molecules.

Furthermore, molecular mechanics simulations (MM) were employed to illustrate changes in intermolecular interactions upon introduction of bulky substituents. Results demonstrated useful deviation from solubility parameters for non-substituted thiosemicarbazones compared to those with bulky groups, indicating improved miscibility and dissolution properties. The theoretical studies also explored alternative solvent systems such as acetone-dichloromethane mixtures or other combinations of organic solvents. The results showed that these alternatives may offer enhanced dissolution properties without compromising corrosion inhibition performance.

DFT calculations revealed, in examples, that the introduction of cyclohexyl and ethlyphenyl groups usefully altered the molecular structure, leading to a reduction in planarity due to steric hindrance between these bulky substituents and aromatic rings. This disruption was further confirmed by quantum mechanical simulations using Schrödinger software package, which showed useful changes in electronic density distribution upon addition of cyclohexyl group compared to unsubstituted Schiff bases.

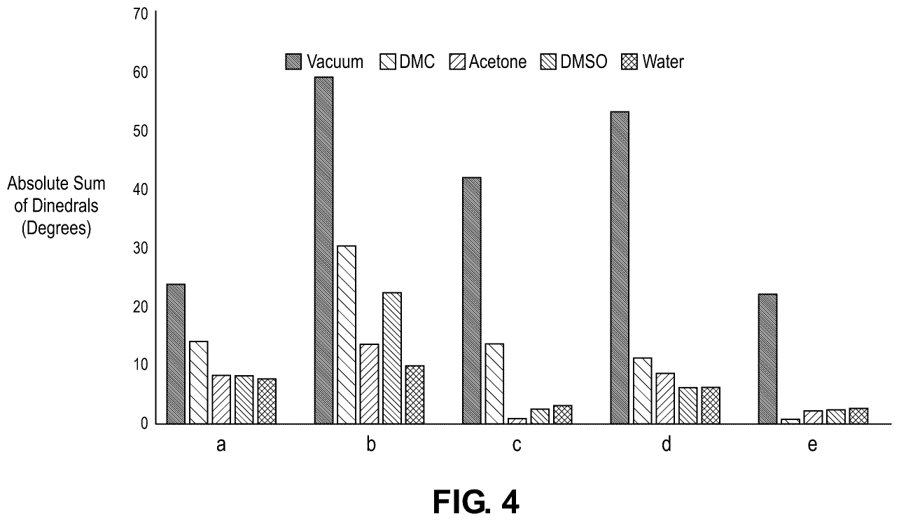

FIG. 4 is a plot depicting absolute sum of dihedral angles of thio-groups relative to a central benzyl ring as a function of dielectric environment, in accordance with the present disclosure. A sum of dihedral angles of thio-groups in relation to the central benzyl ring are plotted as a function of dielectric environment indicates that the introduction of candidate Schiff base groups into dielectric media promotes flattening of structures, which can lead to π-π stacking and subsequent collapse out of solution. DFT results shown in FIG. 4 illustrate that bulky substituent addition has significant impacts on the relative solvation energy and disrupt the local planar environment. These results show promise in disrupting the π-π stacking environment of the substituted thiosemicarbazones. The results of QM studies are corroborated with MM simulations, which allow the computation of solubility parameters.

In examples, MM calculations employing the OPLS3 force field demonstrated that the addition of bulky substituents increased intermolecular distances and reduced π-π stacking interactions between molecules. This was attributed to steric hindrance from these groups, which prevented close packing of aromatic rings in a stack. The MM simulations also revealed changes in dihedral angles around thio-group relative to the central benzyl ring upon addition of bulky substituents. MD simulations using Schrödinger software package were employed to investigate solvation properties and solvent-solute interactions for Schiff bases with different types of bulky substituents. The results showed that molecules containing cyclohexyl group exhibited higher solubility in polar solvents such as water due to increased distance between aromatic rings, whereas those with ethlyphenyl groups displayed improved dissolution behavior in non-polar solvents like hexane. In additional examples, the effects of bulky substituents on molecular dynamics were studied using Schrödinger software package. The simulations revealed that cyclohexyl group introduced useful steric hindrance around thio-group and aromatic rings, leading to reduced π-π stacking interactions between molecules in solution. This was accompanied by changes in solvent-solute interactions, with polar solvents exhibiting stronger binding energies compared to nonpolar ones.

In yet another example, the geometric changes caused by bulky substituent addition were investigated using ab initio calculations employing Schrödinger software package. The results showed that cyclohexyl group introduced useful steric hindrance around aromatic rings and thio-group, leading to reduced planarity of molecules in solution. This was accompanied by changes in electronic density distribution upon substitution. In a further example, the effects of bulky substituents on molecular structure were studied using semi-empirical calculations employing Schrödinger software package. The results revealed that cyclohexyl group introduced useful steric hindrance around aromatic rings and thio-group, leading to reduced π-π stacking interactions between molecules in solution. These multiscale modeling techniques provided valuable insights into the geometric changes caused by bulky substituent addition to Schiff bases, shedding light on their effects on molecular structure, solvation properties, solvent-solute interactions, and electronic density distribution.

Specifically, DFT calculations were performed to determine the electronic structure environment for each candidate compound by optimizing its geometry within a dielectric medium of varying polarity and composition. This allowed investigation of how bulky substituents affect π-π stacking interactions between molecules as well as their solvation properties. In an example, the simulation of thiosemicarbazone derivatives with 2-ethylphenyl (Formula b), 3-ethlyphenyl group (Formula c) and cyclohexyl groups (Formula d) attached to the aromatic ring system showed that these bulky substituents alter the electronic structure environment by disrupting π-π stacking interactions, leading to reduced intermolecular forces between molecules in a stack.

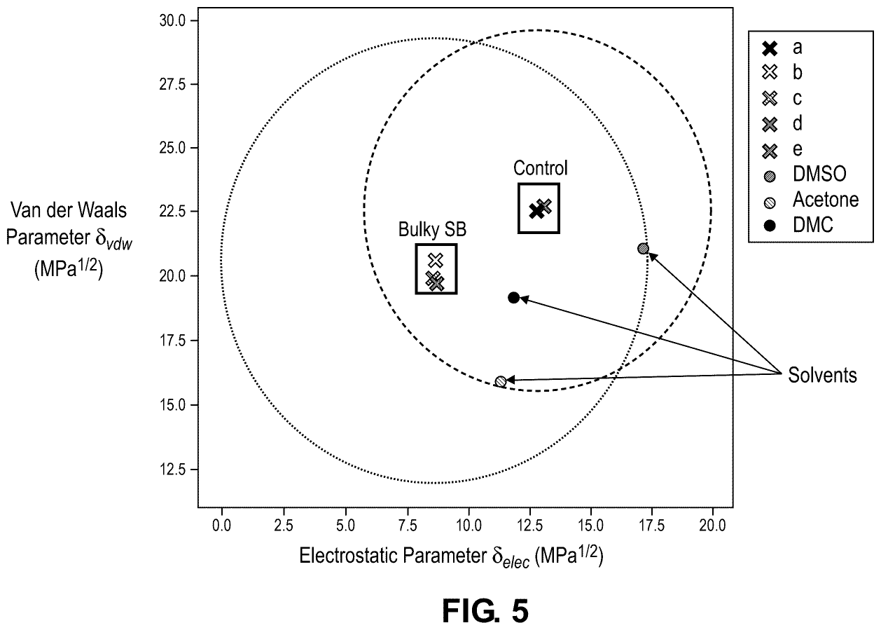

FIG. 5 is a plot depicting solubility parameters of bulky substituents computed via molecular dynamic simulations, in accordance with the present disclosure. Solubility Parameters computed via MD simulations have a “like dissolves like” relationship, such that similar values denote miscibility between solvent pairs. In the plot, circles are generated for known or predicted solubility. As indicated in the plot of FIG. 5, the compounds with bulky substituents, Formula b, Formula c, and Formula d, are clustered away from candidates represented by Formula a and Formula e, meaning that solvation environment of the modified SB compounds of the present disclosure is significantly different. FIG. 5 shows solubility parameter plots that demonstrate the significant deviation from solubility between non-substituted as compared to substituted thiosemicarbazides. Molecular mechanics techniques were employed to compute solubility parameters using Hansen Solubility Parameters (HSP) for each proposed compound in various solvent media. The present results indicate that molecules with bulky substituents exhibit improved miscibility compared to those without such functionality, indicating enhanced dissolution properties due to reduced intermolecular interactions.

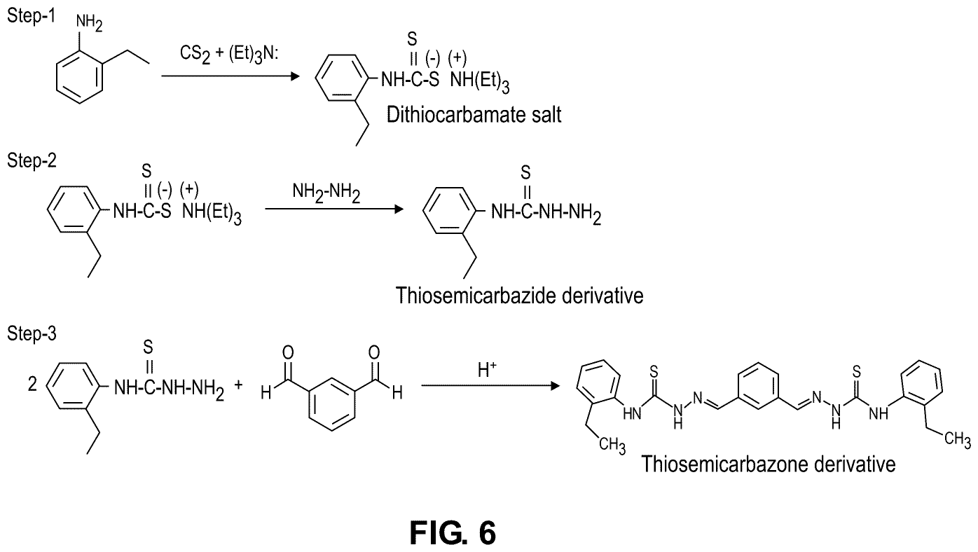

FIG. 6 is a reaction scheme illustrating a method of forming a corrosion inhibiting composition, in accordance with the present disclosure. As molecules with bulky substituents as proposed improve the solubility of bis-functional SBs due to reduced intermolecular π-π stacking, and the theoretical studies described herein support flattening of the molecules with bulky substituents should indicate favorable solubility, the synthesis of the molecules with bulky substituents and polar bulky substituents can be accomplished as shown in FIG. 6. Step-1 includes an exemplary bulky substituent group, consistent with one shown in regard to Formula b, reacted with carbon disulfide (CS₂) and triethylamine ((Et)₃N) to produce a dithiocarbamate salt as shown. In Step-2, the dithiocarbamate salt is reacted with hydrazine (NH₂—NH₂) to produce the thiosemicarbazide derivative as shown. Step-3 includes reacting the thiosemicarbazide derivative with isophthalaldehyde in acidic media to obtain the thiosemicarbazone derivative compound. Preliminary solubility testing, as described later, shows solubility of the molecules with bulky substituents as higher than that of the control molecule, up to 24 times more than the control molecule. Once synthesized, these molecules can then be polymerized or attached to a polymeric resin and then applied as a coating to mild steel panels or other suitable substrates. One skilled in the art should understand that this exemplary procedure can be extended to or used for other polymeric Schiff base compositions comprising thiosemicarbazide derivatives incorporating alternate bulky substituent groups.

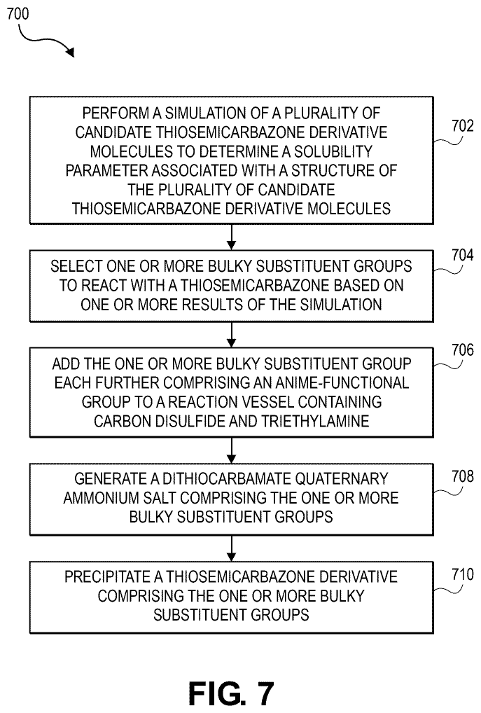

FIG. 7 is a flowchart illustrating a method of forming a corrosion inhibiting composition, in accordance with the present disclosure. The method 700 of forming a corrosion inhibiting composition as described herein, includes performing a simulation of a plurality of candidate thiosemicarbazone derivative molecules to determine a solubility parameter associated with a structure of the plurality of candidate thiosemicarbazone derivative molecules 702, then selecting one or more bulky substituent groups to react with a thiosemicarbazone based on one or more results of the simulation 704. Next, the method 700 includes adding the one or more bulky substituent group each further comprising an amine-functional group to a reaction vessel containing carbon disulfide and triethylamine 706, generating a dithiocarbamate quaternary ammonium salt comprising the one or more bulky substituent groups 708, and precipitating a thiosemicarbazone derivative comprising the one or more bulky substituent groups 710. In examples of the method 700, the one or more bulky substituent groups includes a cyclohexyl group. Other examples of the method 700 include the use of bulky substituent groups comprising a 2-ethyl group, a 3-ethyl group, or a combination thereof, which can alternatively include 2-ethylphenyl and 3-ethylphenyl. In other examples, the one or more bulky substituent groups are selected from a group consisting of aryl groups. The method 700 can further include a step of dissolving the thiosemicarbazone derivative into a solvent to confirm a solubility of the corrosion inhibiting composition or polymerizing the thiosemicarbazone derivative into a polymeric resin. Exemplary polymeric resins can include an epoxy, a polyimide, a polyamide-imide, a polyimide, or a polysiloxane. In other examples, isocyantes, or silane coupling agents can also be incorporated into the formulations.

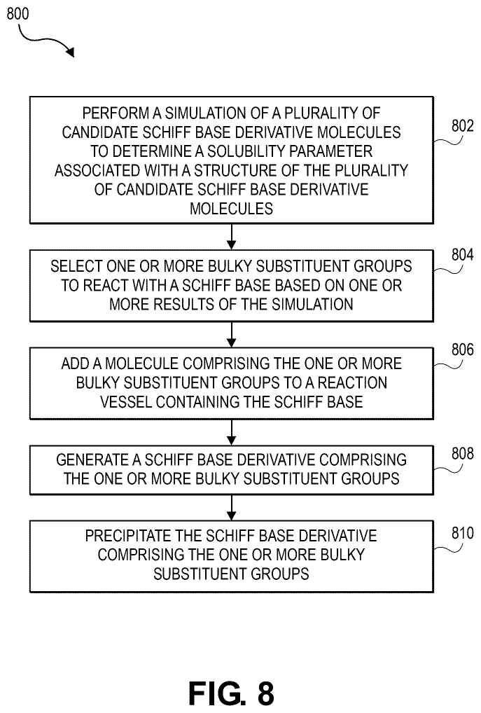

FIG. 8 is a flowchart illustrating a method of forming a corrosion inhibiting composition, in accordance with the present disclosure. The method 800 of forming a corrosion inhibiting composition, includes the steps of performing a simulation of a plurality of candidate Schiff base derivative molecules to determine a solubility parameter associated with a structure of the plurality of candidate Schiff base derivative molecules 802, selecting one or more bulky substituent groups to react with a Schiff base based on one or more results of the simulation 804, adding a molecule comprising the one or more bulky substituent groups to a reaction vessel containing the Schiff base 806, generating a Schiff base derivative comprising the one or more bulky substituent groups 808, and precipitating the Schiff base derivative comprising the one or more bulky substituent groups 810. In examples, the one or more bulky substituent groups comprises 4-chloro-3-nitrobenzaldehyde. The method 800 of forming a corrosion inhibiting composition can further include dissolving the Schiff base derivative into a solvent to confirm a solubility of the corrosion inhibiting composition, polymerizing the Schiff base derivative into a polymeric resin, such as, for example, the resins described previously herein.

### Examples

The general procedure for performing the method, as previously described in regard to FIG. 6, is described in the steps below:

### Step-1:

1. Amine containing bulky substituent group was dissolved in ethanol and introduced into a 3-necked round bottom flask.
2. A mixture of Carbon disulphide (CS₂) and triethylamine was added to the above flask over a period of 1 hr while maintaining the reaction mixture at a temperature between 25° C. and 30° C. The reaction mixture was then stirred for an hour to generate the alkyl/aryl dithiocarbamate quaternary ammonium salt. In other examples, solvent mixtures including dichloromethane and tetrahydrofuran, or dimethyl formamide could alternately be used at room temperature. This reaction may be optimized by using catalysts like copper (I) iodide or silver nitrate to improve yields.
3. This material was used in-situ in the next step.

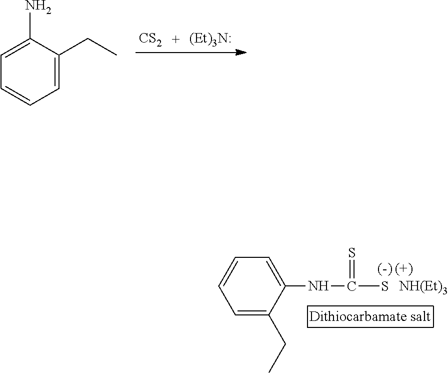

### Step-2:

4. Hydrazine Hydrate dissolved in ethanol was added to a round-bottom flask and the mixture was heated to 102° C.
5. The reaction mixture obtained at the end of Step-1 was then added over 1 hour while distilling off an equal volume of ethanol.
6. An additional 130 ml ethanol was then added while simultaneously distilling off an equal volume of ethanol.
7. The reaction mixture was then cooled to 65° C. Precipitation started to form.
8. After this, the reaction mixture was cooled to 0° C., stirred for half an hour and filtered.
9. Filter cake was washed with 50 ml ethanol and dried in heated air in an oven at 60° C.

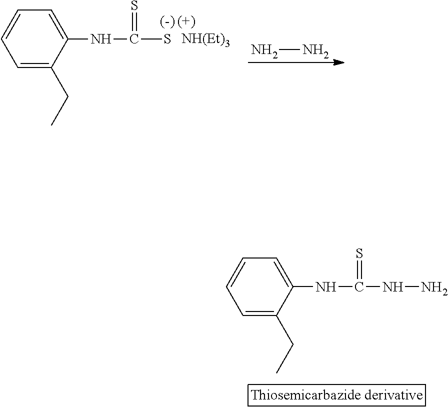

### Step-3

10. The synthesized bulky substituted thiosemicarbazide was reacted with isophthalaldehyde in acidic medium.
11. The product was vacuum filtered and then dried in oven. To evaluate preliminary solubilities, samples are prepared by dissolving each compound in various solvent systems such as acetone-isopropanol-ethanol mixtures at room temperature for 24 hours. The resulting solutions may then be filtered through a membrane filter with pore size of approximately 0.2 micrometers to remove any insoluble particles.

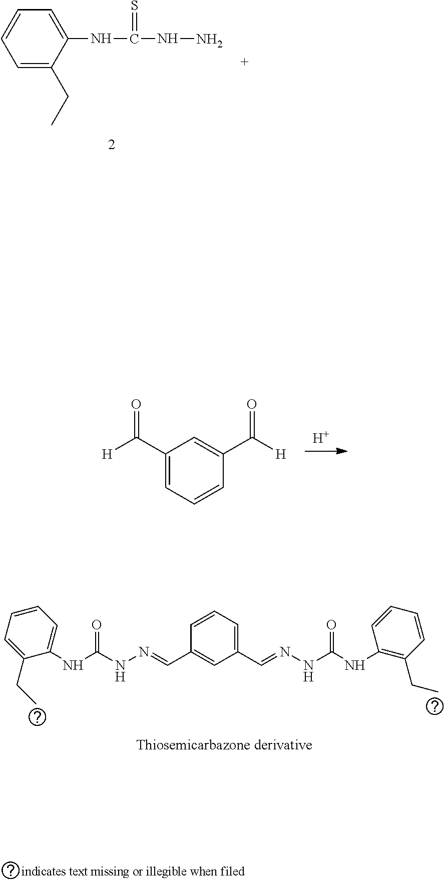 [SMILES: CCc1ccccc1NC(=S)NN ; O=Cc1cccc(C=O)c1 ; CCc1ccccc1NC(=O)N/N=C/c1cccc(/C=N/NC(=O)Nc2ccccc2CC)c1]

### General Synthesis Procedure for Molecule (Formula e):

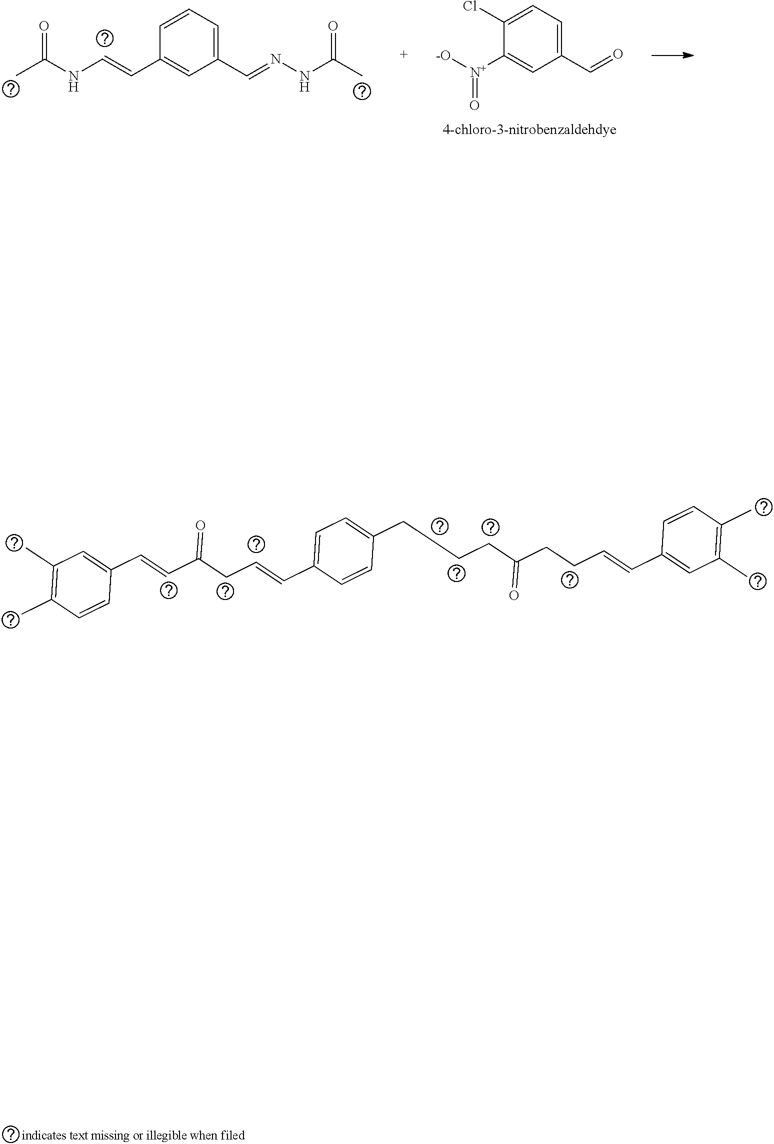

1. Schiff base was added to DMF in a round bottom (RB) flask. Schiff base dissolved immediately in DMF. The solution was stirred and heated to 60° C.
2. 4-chloro-3-nitrobenzaldehdye was dissolved in DMF and the solution was added dropwise to the above RB flask. The combined solution was refluxed and heated for 30 min.
3. A small aliquot of 20 mL was taken out and then 0.190 g of p-Toluene sulfonic acid was added to the reaction flask. The flask was heated and refluxed for another 30 min.
4. The product was washed with water.

### Characterization

To further optimize synthesis conditions for Schiff bases and compounds thereof, various techniques can be employed, such as high-performance liquid chromatography (HPLC) or gas chromatography-mass spectrometry (GC-MS) analysis of reaction mixtures during condensation reactions. This can provide a means of monitoring regioselectivity and yield while minimizing side products formation. In examples, the reaction conditions can be optimized by adjusting temperature, pressure, or catalysts to improve yields of up to 80%. The resulting compounds may be characterized using techniques like FTIR and NMR spectroscopy. Solubility testing can include measuring the amount of dissolved compound in each solvent system using techniques like UV-Vis spectroscopy or HPLC analysis. In other examples, weighing a maximum amount of SB that could be dissolved in a certain volume of the solvent can provide a saturated solution. For example, Schiff base derivatives containing cyclohexyl group exhibit higher dissolution properties compared to those without this bulky substituent when tested with acetone-dichloromethane mixtures. Additionally, solubility testing may be performed by monitoring the change in absorbance at a specific wavelength (e.g., 400 nm) over time using UV-Vis spectroscopy. This approach allows for real-time evaluation of dissolution properties and provides valuable insights into molecular interactions between solvent-solute systems.

In examples, the Schiff bases may be synthesized into polymeric resins through ring-opening metathesis polymerization (ROMP) reactions using ruthenium-based catalysts or other suitable initiators. This approach can enable the creation of polymers with tailored molecular weights and architectures that may further influence coating properties such as solubility, adhesion, and corrosion inhibition performance.

In examples of the present disclosure, increases of solubility from about 1.79 to about 43.33 g/L can be achieved. In examples, up to 100 g/L can be reasonably achieved as well. Increased solubility is a primary goal of the methods and compositions of the present disclosure in order to improve the concentration of the corrosion inhibiting compositions in an applied coating or surface treatment.

Additional aspects of the present disclosure can include a corrosion inhibiting composition for preventing corrosion on Al alloy or other substrate panels, including a bis-functional Schiff base molecule comprising bulky substituents selected from the group consisting of cyclohexyl groups and polar functional groups, wherein the bulkiness induces steric hindrance around an aromatic ring system to reduce π-π stacking interactions between molecules. The corrosion inhibiting composition can further include a polymeric resin attached thereto through condensation reactions or other suitable methods or wherein the bulky substituents are cyclohexyl groups that adopt chair or boat configurations to induce steric hindrance around the aromatic ring system. The corrosion inhibiting composition can further include a thermoplastic material with excellent adhesion properties on substrate surfaces due to chemical bonding with metal oxides present at the surface. The corrosion inhibiting composition can alternately include Schiff base molecules synthesized through reaction of thiosemicarbazone derivatives and a polar functional group-containing compound. The corrosion inhibiting composition can incorporate additional solvents such as dichloromethane and tetrahydrofuran for optimal synthesis conditions during condensation reactions involved in its preparation. The corrosion inhibiting composition can provide where the Schiff base molecule exhibits improved dissolution properties due to reduced π-π stacking interactions between molecules caused by bulky substituents. The corrosion inhibiting composition can have an applied thickness ranging from 1-10 micrometers and surface roughness less than 100 nanometers on substrate surfaces after application as a coating material. The corrosion inhibiting composition can include a Schiff base molecule that is synthesized using alternative bulkiness-inducing moieties such as aryl groups (e.g., phenyl) or heterocycles (e.g., pyridine rings). The corrosion inhibiting composition can alternately include a polar functional group-containing compound that enhances reactivity towards metal ions and other species involved in corrosion reactions. The molecules designed according to the present disclosure can be applied as a coating to the ZnNi, Zn, Cd plated panels or Al alloy panels or other substrates as described herein.

While the present teachings have been illustrated with respect to one or more implementations, alterations and/or modifications may be made to the illustrated examples without departing from the spirit and scope of the appended claims. For example, it may be appreciated that while the process is described as a series of acts or events, the present teachings are not limited by the ordering of such acts or events. Some acts may occur in different orders and/or concurrently with other acts or events apart from those described herein. Also, not all process stages may be required to implement a methodology in accordance with one or more aspects or embodiments of the present teachings. It may be appreciated that structural objects and/or processing stages may be added, or existing structural objects and/or processing stages may be removed or modified. Further, one or more of the acts depicted herein may be carried out in one or more separate acts and/or phases. Furthermore, to the extent that the terms “including,” “includes,” “having,” “has,” “with,” or variants thereof are used in either the detailed description and the claims, such terms are intended to be inclusive in a manner similar to the term “comprising.” The term “at least one of” is used to mean one or more of the listed items may be selected. Further, in the discussion and claims herein, the term “on” used with respect to two materials, one “on” the other, means at least some contact between the materials, while “over” means the materials are in proximity, but possibly with one or more additional intervening materials such that contact is possible but not required. Neither “on” nor “over” implies any directionality as used herein. The term “conformal” describes a coating material in which angles of the underlying material are preserved by the conformal material. The term “about” indicates that the value listed may be somewhat altered, as long as the alteration does not result in nonconformance of the process or structure to the illustrated embodiment. The terms “couple,” “coupled,” “connect,” “connection,” “connected,” “in connection with,” and “connecting” refer to “in direct connection with” or “in connection with via one or more intermediate elements or members.” Finally, the terms “exemplary” or “illustrative” indicate the description is used as an example, rather than implying that it is an ideal. Other embodiments of the present teachings may be apparent to those skilled in the art from consideration of the specification and practice of the disclosure herein. It is intended that the specification and examples be considered as exemplary only, with a true scope and spirit of the present teachings being indicated by the following claims.

What is claimed is:

1. A method of forming a corrosion inhibiting composition, comprising:
performing a simulation of a plurality of candidate thiosemicarbazone derivative molecules to determine a solubility parameter associated with a structure of the plurality of candidate thiosemicarbazone derivative molecules;
selecting one or more bulky substituent groups to react with a thiosemicarbazone based on one or more results of the simulation;
adding the one or more bulky substituent group each further comprising an amine-functional group to a reaction vessel containing carbon disulfide and triethylamine;
generating a dithiocarbamate quaternary ammonium salt comprising the one or more bulky substituent groups; and
precipitating a thiosemicarbazone derivative comprising the one or more bulky substituent groups.

2. The method of forming a corrosion inhibiting composition of claim 1, wherein the one or more bulky substituent groups comprises a cyclohexyl group.

3. The method of forming a corrosion inhibiting composition of claim 1, wherein the one or more bulky substituent groups comprises a 2-ethyl group, a 3-ethyl group, or a combination thereof.

4. The method of forming a corrosion inhibiting composition of claim 3, wherein the one or more bulky substituent groups is selected from a group consisting of 2-ethylphenyl and 3-ethylphenyl.

5. The method of forming a corrosion inhibiting composition of claim 1, wherein the one or more bulky substituent groups are selected from a group consisting of aryl groups.

6. The method of forming a corrosion inhibiting composition of claim 1, further comprising dissolving the thiosemicarbazone derivative into a solvent to confirm a solubility of the corrosion inhibiting composition.

7. The method of forming a corrosion inhibiting composition of claim 1, further comprising polymerizing the thiosemicarbazone derivative into a polymeric resin.

8. The method of forming a corrosion inhibiting composition of claim 7, wherein the polymeric resin comprises an epoxy, a polyimide, a polyamide-imide, a polyimide, or a polysiloxane.

9. A method of forming a corrosion inhibiting composition, comprising:
performing a simulation of a plurality of candidate Schiff base derivative molecules to determine a solubility parameter associated with a structure of the plurality of candidate Schiff base derivative molecules;
selecting one or more bulky substituent groups to react with a Schiff base based on one or more results of the simulation;
adding a molecule comprising the one or more bulky substituent groups to a reaction vessel containing the Schiff base;
generating a Schiff base derivative comprising the one or more bulky substituent groups; and
precipitating the Schiff base derivative comprising the one or more bulky substituent groups.

10. The method of forming a corrosion inhibiting composition of claim 9, wherein the one or more molecule comprising the one or more bulky substituent groups comprises 4-chloro-3-nitrobenzaldehyde.

11. The method of forming a corrosion inhibiting composition of claim 9, further comprising:
dissolving the Schiff base derivative into a solvent to confirm a solubility of the corrosion inhibiting composition; and
polymerizing the Schiff base derivative into a polymeric resin.

12. A corrosion inhibition coating composition, comprising:
a polymer resin; and
a thiosemicarbazone derivative; and wherein:
the thiosemicarbazone derivative comprises one or more bulky substituent moieties.

13. The corrosion inhibition coating composition of claim 12, wherein the one or more bulky substituent moieties comprises a cyclohexyl group.

14. The corrosion inhibition coating composition of claim 13, wherein the one or more bulky substituent moieties comprises a 2-ethyl group, a 3-ethyl group, a polar 4-chloro-3-nitrophenyl group, or a combination thereof.

15. The corrosion inhibition coating composition of claim 12, wherein the one or more bulky substituent moieties is selected from a group consisting of 2-ethylphenyl, 3-ethylphenyl, and 4-chloro-3-nitrophenyl.

16. The corrosion inhibition coating composition of claim 12, wherein the bulky substituent moieties are selected from a group consisting of aryl groups.

17. The corrosion inhibition coating composition of claim 12, wherein the corrosion inhibition coating composition has a thickness ranging from about 5 nanometers to about 10 micrometers.

18. The corrosion inhibition coating composition of claim 12, wherein the thiosemicarbazone derivative comprises a thiosemicarbazone of isophthalaldehyde or a thiosemicarbazone of terephthalaldehyde.

19. The corrosion inhibition coating composition of claim 12, the polymer resin comprises a thermoset material.

20. The corrosion inhibition coating composition of claim 12, wherein the polymeric resin comprises an epoxy, a polyimide, a polyamide-imide, a polyimide, or a polysiloxane.
